(19) United States
(12) Patent Application Publication
(10) Pub. No.: US 2020/0010026 A1
(43) Pub. Date: Jan. 9, 2020

(54) SNAP-ON COVER FOR VEHICLE DOOR HANDLE

(71) Applicant: Naje A. Fattouche, Bowie, MD (US)

(72) Inventor: Naje A. Fattouche, Bowie, MD (US)

(21) Appl. No.: 16/030,775

(22) Filed: Jul. 9, 2018

(51) Int. Cl. B60R 13/04; E05B 85/10

(52) U.S. Cl. CPC B60R 13/04; E05B 85/10

(57) ABSTRACT

A door handle cover adapted for engagement to a door handle on a vehicle, comprising an elongate panel having an upper lip along an upper longitudinal edge thereof and a lower lip along a lower longitudinal edge thereof, the upper lip comprising a generally hook-shaped member that defines an interior region adapted to grippingly engage an upper portion of the door handle, the lower lip comprising a generally hook-shaped member that defines an interior region adapted to grippingly engage a lower portion of the door handle, wherein upon engagement of the upper lip and lower lip on the door handle the cover is thereby firmly affixed to the door handle.

### TECHNICAL FIELD

The presently disclosed subject matter relates to door handle covers and, more particularly, to door handle covers for automobile door handles.

### BACKGROUND

After-market trim components for automobiles are components which can be added to an automobile to add decoration and customization to a vehicle beyond what is supplied by the vehicle manufacturer. One such trim component is a door handle cover which fits over the manufacturer's installed exterior door handle and provides a customized look. An after-market door handle cover is typically custom manufactured to precisely fit over a specific one or more door handles of a specific vehicle or vehicles. Commonly, after-market vehicle door handle covers are finished in a chrome or black finish, thus providing a new look to the automobile installed thereon.

The automobile door handle covers which are known in the art are typically fastened to the door handle and held in place using a bonding material such as double-sided tape or glue.

Thus the prior art door handle covers require the application of secondary components for affixing to the door handle (i.e. tape, glue, clips, etc.). This makes installation somewhat tedious, inconvenient and perhaps even messy. Furthermore, these door handle covers are prone to loosen over time with repeated use of the door handle.

### GENERAL DESCRIPTION

One objective of the present invention is to provide an improved door handle cover capable of being snapped-on to the door handle, without requiring the use of double-sided tape or other bonding material, or clips, to hold the door handle cover in place.

Another objective of the present invention is to provide a door handle cover constructed of rigid material capable of being flexed, and optionally constructed of a single piece of polymer material, capable of affixing to a door handle cover without any additional components.

One or more of these or other objects of the invention will be apparent from the specification and claims that follow.

Therefore, in accordance with certain aspects of the presently disclosed subject matter, there is provided a door handle cover adapted for engagement to a door handle on a vehicle, said cover comprising an elongate panel having an upper lip along an upper longitudinal edge thereof and a lower lip along a lower longitudinal edge thereof, said upper lip comprising a generally hook-shaped member that defines an interior region adapted to grippingly engage an upper portion of said door handle, said lower lip comprising a generally hook-shaped member that defines an interior region adapted to grippingly engage a lower portion of said door handle, wherein upon engagement of the upper lip and lower lip on said door handle the cover is thereby firmly affixed to said door handle.

In accordance with further aspects and, optionally, in combination with other aspects of the presently disclosed subject matter, a rear surface of said elongate panel is contoured to precisely conform to at least a portion of the visible surface of said door handle such that upon engagement of the upper lip and lower lip on said door handle, said elongate panel is intended to be flush against the door handle.

In accordance with further aspects and, optionally, in combination with other aspects of the presently disclosed subject matter, the elongate panel may be composed of a rigid polymer material that can be temporarily flexed during installation of said cover on said door handle.

In accordance with further aspects and, optionally, in combination with other aspects of the presently disclosed subject matter, the elongate panel is manufactured from a rigid material that allows for manipulation of the panel during installation on said door handle to facilitate engagement of the upper lip and lower lip to the upper portion and lower portion of the door handle respectively.

In accordance with further aspects and, optionally, in combination with other aspects of the presently disclosed subject matter, the front surface of the elongate panel is finished in a decorative finish.

In accordance with further aspects and, optionally, in combination with other aspects of the presently disclosed subject matter, the cover can be snapped on to said door handle and held firmly in place by means of said upper lip and lower lip engaging said door handle.

Among advantages of certain embodiments of the presently disclosed subject matter is that the cover can be snapped on to the door handle and held firmly in place on the door handle by means of the upper lip and lower lip, without requiring the use of double sided tape or clips to hold the cover in place.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an elevated perspective view of a vehicle door handle cover in accordance with certain embodiments of the presently disclosed subject matter;

FIG. 2 illustrates a frontal view of the vehicle door handle cover in accordance with certain embodiments of the presently disclosed subject matter; and

FIG. 3 illustrates a cross-sectional view of the vehicle door handle cover along an axis perpendicular to a longitudinal axis of the cover in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, and components have not been described in detail so as not to obscure the presently disclosed subject matter.

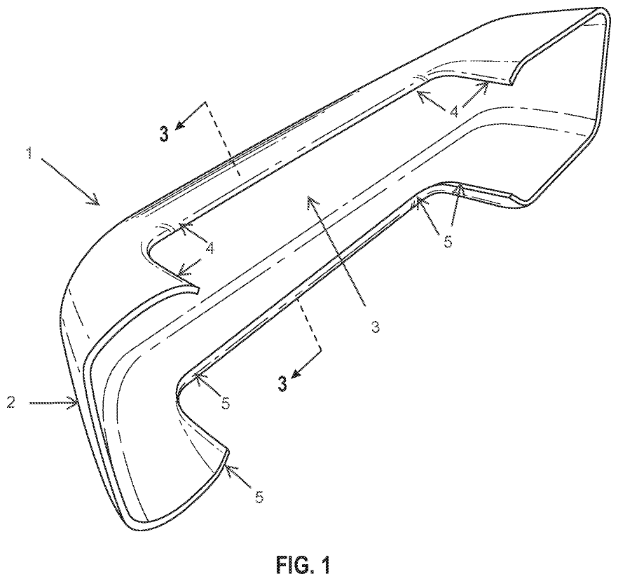

Bearing this in mind, attention is drawn to FIGS. 1-3 illustrating a vehicle door handle cover in accordance with certain embodiments of the presently disclosed subject matter. As shown in FIG. 1, the cover comprises an elongate panel 1 having an upper lip 4 along its upper longitudinal edge, and a lower lip 5 along its lower longitudinal edge. Each of the upper lip 4 and lower lip 5 comprise a generally hook-shaped member that defines an upper and lower interior region, respectively, and are adapted to grippingly engage the door handle. That is, the upper lip 4 defines an interior region adapted to grippingly engage an upper portion of the vehicle door handle, while the lower lip 5 defines an interior region adapted to grippingly engage a lower portion of the vehicle door handle. The cover is manufactured to conform to the shape of the specific door handle to which it is to be used for, such that upon engagement of the upper lip 4 and lower lip 5 on the door handle, the cover is thereby firmly affixed to the door handle.

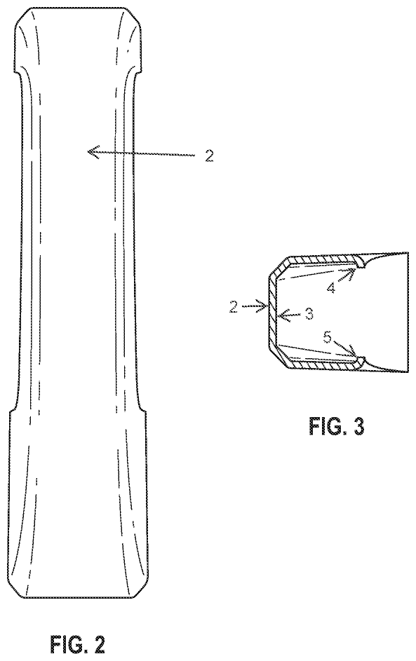

As shown in FIG. 2, in some cases a front surface 2 of the cover can be shaped or contoured to generally match a shape or contour of a door handle, in order to preserve the general appearance of a manufacturer supplied door handle, if it is desirable to do so.

In some case the front surface 2 of the cover can be finished in a decorative finish to provide a personalized or customized look. For example, the front surface 2 can be finished in chrome, or in a different color from that of the door handle itself. In some cases the front surface 2 can include other decorative elements.

In some embodiments, as shown in FIG. 3, a rear surface 3 of the elongate panel is shaped to precisely conform to a visible surface of a door handle such that upon engagement of the upper lip 4 and lower lip 5 on the door handle, a rear surface 3 of the elongate panel is flush against the door handle, thereby reducing or eliminating any movement of the cover on the door handle when a user grips and pulls the door handle to open a vehicle door.

In some cases, the door handle may be curved or contoured. In such a case the rear surface 3 (including the interior surface of upper lip 4 and lower lip 5) can be similarly contoured to precisely conform to at least a portion of the visible surface of the door handle.

Preferably, the cover is made of a rigid polymer material that can be temporarily flexed by applying force or pressure to the cover. However it is not necessary for the cover to be made of a polymer; any suitable rigid material capable of being flexed would work.

In certain embodiments, the cover is installed on a door handle by first manipulating the cover (e.g. by bending or flexing it) so that the distance between the upper and lower longitudinal edges of the cover is greater than the height of the door handle, allowing the edges to clear the door handle. Next, the cover is slid over the door handle and the pressure is relaxed. The relaxation will cause the cover to return to its natural rigid state, and grasp the door handle between the upper lip 4 and lower lip 5. Alternatively, the cover may also be installed by placing the cover over the door handle so that one of the lips (i.e. either the upper lip 4 or the lower lip 5) is aligned with a corresponding portion of the door handle, and subsequently manipulating the cover until an opposing lip engages with an opposing surface of the door handle.

It should be appreciated that the disclosed snap-on door handle cover can be manufactured according to precise predetermined specifications (i.e. for a specific door handle of a particular make and model of vehicle) that can ensure the cover will sit firmly and securely on the door handle for which it is made without requiring bonding material, such as glue or double sided tape. However, such bonding material may also be used, if desired, with the disclosed snap-on cover.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A door handle cover adapted for engagement to a door handle on a vehicle, said cover comprising an elongate panel having an upper lip along an upper longitudinal edge thereof and a lower lip along a lower longitudinal edge thereof, said upper lip comprising a generally hook-shaped member that defines an interior region adapted to grippingly engage an upper portion of said door handle, said lower lip comprising a generally hook-shaped member that defines an interior region adapted to grippingly engage a lower portion of said door handle, wherein upon engagement of the upper lip and lower lip on said door handle the cover is thereby firmly affixed to said door handle.

2. The door handle cover of claim 1, wherein a rear surface of said elongate panel is contoured to precisely conform to at least a portion of the visible surface of said door handle such that upon engagement of the upper lip and lower lip on said door handle, said elongate panel is intended to be flush against the door handle.

3. The door handle cover of claim 1, wherein said elongate panel may be composed of a rigid polymer material that can be temporarily flexed during installation of said cover on said door handle.

4. The door handle cover of claim 1, wherein the elongate panel is manufactured from a rigid material that allows for manipulation of the panel during installation on said door handle to facilitate engagement of the upper lip and lower lip to the upper portion and lower portion of the door handle respectively.

5. The door handle cover of claim 1, wherein a front surface of the elongate panel is finished in a decorative finish.

6. The door handle cover of claim 1, wherein said cover can be snapped on to said door handle and held firmly in place by means of said upper lip and lower lip engaging said door handle.
